(19) United States
(12) Patent Application Publication
(10) Pub. No.: US 2025/0213025 A1
(43) Pub. Date: Jul. 3, 2025

(54) LOCKOUT CLIP

(71) Applicant: Seaver Safety Concepts, LLC, West Haven, UT (US)

(72) Inventors: Casey Robert Seaver, West Haven, UT (US); Andrew Quinn Nelson, Wellsville, UT (US)

(21) Appl. No.: 18/959,337

(22) Filed: Nov. 25, 2024

Related U.S. Application Data
(60) Provisional application No. 63/617,172, filed on Jan. 3, 2024.

(51) Int. Cl. A45F 5/02; E05B 67/38

(52) U.S. Cl. CPC A45F 5/021; E05B 67/383; E05B 2067/386

(57) ABSTRACT

A lockout clip for carrying padlocks used to lockout equipment includes an anchor section with a first side and a second side opposite the first side, a top edge, a bottom edge distal to the top edge, a first side edge, and a second side edge distal to the first side edge The lockout clip includes a ridge section coupled to the first side of the anchor section and extending away from the first side of the anchor section and is connected to the first side in a direction from the top edge to the bottom edge. The ridge section includes two or more lock openings. Each lock opening is sized for a shackle of a padlock used to lockout access to equipment, and each lock opening of the two or more lock openings is oriented perpendicular to the ridge section. The anchor section includes a clip and/or a magnet.

### CROSS-REFERENCES TO RELATED APPLICATIONS

This application claims the benefit of U.S. Provisional Patent Application No. 63/617,172 entitled “LOCKOUT CLIP” and filed on Jan. 3, 2024 for Casey Robert Seaver, et al., which is incorporated herein by reference for all purposes.

### FIELD

This invention relates to padlocks and more particularly relates to a clip configured to hold several padlocks used to lockout equipment.

### BACKGROUND

Repair crews working on equipment, such as electrical equipment, manufacturing equipment, assembly line equipment, or the like often carry padlocks used to lock equipment in a safe mode to prevent others from turning on the equipment, accessing the equipment, or the like. However, transporting the padlocks is a problem for those repairing the equipment.

### SUMMARY

A lockout clip for carrying padlocks used to lockout equipment includes an anchor section with a first side and a second side opposite the first side, a top edge, a bottom edge distal to the top edge, a first side edge, and a second side edge distal to the first side edge. The lockout clip includes a ridge section coupled to the first side of the anchor section and extending away from the first side of the anchor section and is connected to the first side in a direction from the top edge to the bottom edge. The ridge section includes two or more lock openings. Each lock opening is sized for a shackle of a padlock used to lockout access to equipment, and each lock opening of the two or more lock openings is oriented perpendicular to the ridge section. The anchor section includes a clip and/or a magnet.

Another lockout clip for carrying padlocks used to lockout equipment includes a lockout section with an anchor section that includes a first side and a second side opposite the first side, a top edge, a bottom edge distal to the top edge, a first side edge, and a second side edge distal to the first side edge. The lockout clip includes a ridge section coupled to the first side of the anchor section and extending away from the first side of the anchor section and connected to the first side in a direction from the top edge to the bottom edge. The ridge section includes two or more lock openings. Each lock opening is sized for a shackle of a padlock used to lockout access to equipment, and each lock opening of the two or more lock openings oriented perpendicular to the ridge section. The lockout clip includes a coupling section and a clip section. The coupling section is coupled to a top edge of the clip section and to the top edge of the lockout section. The coupling section shaped to maintain a gap between the clip section and the lockout section.

Another lockout clip for carrying padlocks used to lockout equipment includes an anchor section with a first side and a second side opposite the first side, a top edge, a bottom edge distal to the top edge, a first side edge, and a second side edge distal to the first side edge. The lockout clip includes a ridge section coupled to the first side of the anchor section and extending away from the first side and connected to the first side in a direction from the top edge to the bottom edge. The ridge section includes two or more lock openings. Each lock opening is sized for a shackle of a padlock used to lockout access to equipment, and each lock opening of the two or more lock openings is oriented perpendicular to the ridge section. The lockout clip includes a magnet disposed within the second side of the anchor section.

### BRIEF DESCRIPTION OF THE DRAWINGS

In order that the advantages of the embodiments will be readily understood, a more particular description of the embodiments briefly described above will be rendered by reference to specific embodiments that are illustrated in the appended drawings. Understanding that these drawings depict only typical embodiments of the embodiments and are not therefore to be considered to be limiting of its scope, the embodiments will be described and explained with additional specificity and detail through the use of the accompanying drawings, in which:

FIG. 1A is a perspective view illustrating a lockout clip with two lock openings, according to various embodiments;

FIG. 1B is another perspective view illustrating the lockout clip of FIG. 1A, according to various embodiments;

FIG. 1C is a side view illustrating the lockout clip of FIG. 1A, according to various embodiments;

FIG. 1D is a front view illustrating the lockout clip of FIG. 1A, according to various embodiments;

FIG. 1E is a back view illustrating the lockout clip of FIG. 1A, according to various embodiments;

FIG. 1F is a top view illustrating the lockout clip of FIG. 1A, according to various embodiments;

FIG. 1G is a bottom view illustrating the lockout clip of FIG. 1A, according to various embodiments;

FIG. 2A is a perspective view illustrating a lockout clip with three lock openings, according to various embodiments;

FIG. 2B is another perspective view illustrating the lockout clip of FIG. 2A, according to various embodiments;

FIG. 2C is a side view illustrating the lockout clip of FIG. 2A, according to various embodiments;

FIG. 2D is a front view illustrating the lockout clip of FIG. 2A, according to various embodiments;

FIG. 2E is a back view illustrating the lockout clip of FIG. 2A, according to various embodiments;

FIG. 2F is a top view illustrating the lockout clip of FIG. 2A, according to various embodiments;

FIG. 2G is a bottom view illustrating the lockout clip of FIG. 2A, according to various embodiments;

FIG. 3A is a perspective view illustrating a lockout clip with four lock openings, according to various embodiments;

FIG. 3B is another perspective view illustrating the lockout clip of FIG. 3A, according to various embodiments;

FIG. 3C is a side view illustrating the lockout clip of FIG. 3A, according to various embodiments;

FIG. 3D is a front view illustrating the lockout clip of FIG. 3A, according to various embodiments;

FIG. 3E is a back view illustrating the lockout clip of FIG. 3A, according to various embodiments;

FIG. 3F is a top view illustrating the lockout clip of FIG. 3A, according to various embodiments;

FIG. 3G is a bottom view illustrating the lockout clip of FIG. 3A, according to various embodiments;

FIG. 4A is a side view of a lockout clip with four lock openings and a magnet, according to various embodiments;

FIG. 4B is a back view illustrating the lockout clip of FIG. 4A, according to various embodiments; and

FIG. 5 is a side view illustrating the lockout clip of FIG. 2A with two padlocks and a key holder and illustrating sliding the lockout clip over a pant with a belt, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that the embodiments may be practiced without one or more of the specific details, or with other methods, components, materials, and so forth. In other instances, well-known structures, materials, or operations are not shown or described in detail to avoid obscuring aspects of the embodiments.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A lockout clip for carrying padlocks used to lockout equipment includes an anchor section with a first side and a second side opposite the first side, a top edge, a bottom edge distal to the top edge, a first side edge, and a second side edge distal to the first side edge The lockout clip includes a ridge section coupled to the first side of the anchor section and extending away from the first side of the anchor section and is connected to the first side in a direction from the top edge to the bottom edge. The ridge section includes two or more lock openings. Each lock opening is sized for a shackle of a padlock used to lockout access to equipment, and each lock opening of the two or more lock openings is oriented perpendicular to the ridge section. The anchor section includes a clip and/or a magnet.

In some embodiments, the anchor section and the ridge section combined are a lockout section and the clip includes a clip section and a coupling section. The coupling section is coupled to a top edge of the clip section and to the top edge of the lockout section. The coupling section is shaped to maintain a gap between the clip section and the lockout section. In other embodiments, the coupling section provides a spring force configured to retain the clip section positioned with respect to the lockout section. In other embodiments, the spring force is sufficient to retain an article within the gap. In other embodiments, the article includes a belt, a pant, a strap, and/or an article with a pocket and a length of the gap is sized to fit over the belt, a portion of waistline of the pant, and/or a portion of a pocket of the article a sufficient amount to retain the article in the gap. In other embodiments, the gap narrows in a direction away from the coupling section. In other embodiments, the second side of the lockout section and/or a side of the clip section facing the gap include one or more protrusions that extend in a direction towards the gap.

In some embodiments, the lockout clip includes a ferromagnetic material. In other embodiments, the lockout clip includes a non-metallic material with the ferromagnetic material spread throughout the non-metallic material. In other embodiments, the non-metallic material with the ferromagnetic material is a material suitable for a three-dimensional (“3D”) printer and/or injection molding. In other embodiments, the two or more lock openings are spaced along the ridge section in a direction from the top edge to the bottom edge.

In some embodiments, the two or more lock openings are offset such that a top lock opening of the two or more lock openings closest to the top edge is spaced farthest from the first side of the anchor section and a bottom lock opening of the two or more lock openings closest to the bottom edge is spaced closest to the first side of the anchor section and any of the two or more lock openings between the top lock opening and the bottom lock opening have a distance to the first side less than the top lock opening and greater than the bottom lock opening. In other embodiments, the two or more lock openings are spaced apart along a line. In other embodiments, the first side of the anchor section extends past the ridge section in a horizontal direction between the first side edge and the second side edge.

Another lockout clip for carrying padlocks used to lockout equipment includes a lockout section with an anchor section that includes a first side and a second side opposite the first side, a top edge, a bottom edge distal to the top edge, a first side edge, and a second side edge distal to the first side edge. The lockout clip includes a ridge section coupled to the first side of the anchor section and extending away from the first side of the anchor section and connected to the first side in a direction from the top edge to the bottom edge. The ridge section includes two or more lock openings. Each lock opening is sized for a shackle of a padlock used to lockout access to equipment, and each lock opening of the two or more lock openings oriented perpendicular to the ridge section. The lockout clip includes a coupling section and a clip section. The coupling section is coupled to a top edge of the clip section and to the top edge of the lockout section. The coupling section is shaped to maintain a gap between the clip section and the lockout section.

In some embodiments, the coupling section provides a spring force configured to retain the clip section positioned with respect to the lockout section. In other embodiments, the gap narrows in a direction away from the coupling section. In other embodiments, the lockout clip includes a ferromagnetic material. In other embodiments, the two or more lock openings are spaced along the ridge section in a direction from the top edge to the bottom edge. In other embodiments, the two or more lock openings are offset such that a top lock opening of the two or more lock openings closest to the top edge is spaced farthest from the first side of the anchor section and a bottom lock opening of the two or more lock openings closest to the bottom edge is spaced closest to the first side of the anchor section and any of the two or more lock openings between the top lock opening and the bottom lock opening have a distance to the first side less than the top lock opening and greater than the bottom lock opening. In other embodiments, the two or more lock openings are spaced apart along a line.

Another lockout clip for carrying padlocks used to lockout equipment includes an anchor section with a first side and a second side opposite the first side, a top edge, a bottom edge distal to the top edge, a first side edge, and a second side edge distal to the first side edge. The lockout clip includes a ridge section coupled to the first side of the anchor section and extending away from the first side of the anchor section and connected to the first side in a direction from the top edge to the bottom edge. The ridge section includes two or more lock openings. Each lock opening is sized for a shackle of a padlock used to lockout access to equipment, and each lock opening of the two or more lock openings is oriented perpendicular to the ridge section. The lockout clip includes a magnet disposed within the second side of the anchor section.

In some embodiments, the magnet includes an outer side facing away from the anchor section, the outer side configured to be flush with the second side of the anchor section.

Food processing plants, manufacturing plants, assembly lines, and other locations with industrial equipment typically have specific lockout procedures to lock the industrial equipment in a safe state during maintenance or when the equipment is not functional and needs to be shut down. Technicians carry padlocks specifically designed to lockout the industrial equipment. The padlocks are typically keyed locks where a key for the locks is in the possession of the technician. The technicians typically carry lockout padlocks in with them, for example, in pockets or tool boxes, which is inconvenient and could cause a safety issue if the padlocks fall out of pockets or tool boxes of the technicians at an inopportune time. Various lockout clips are described herein that provide a convenient, safe way for a technician to transport lockout padlocks and keys.

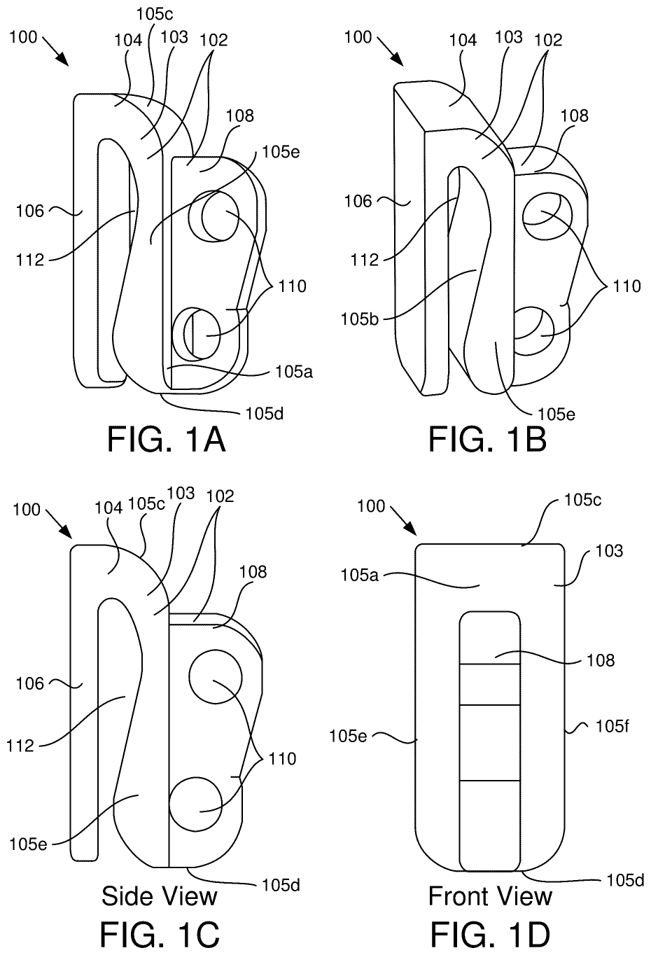

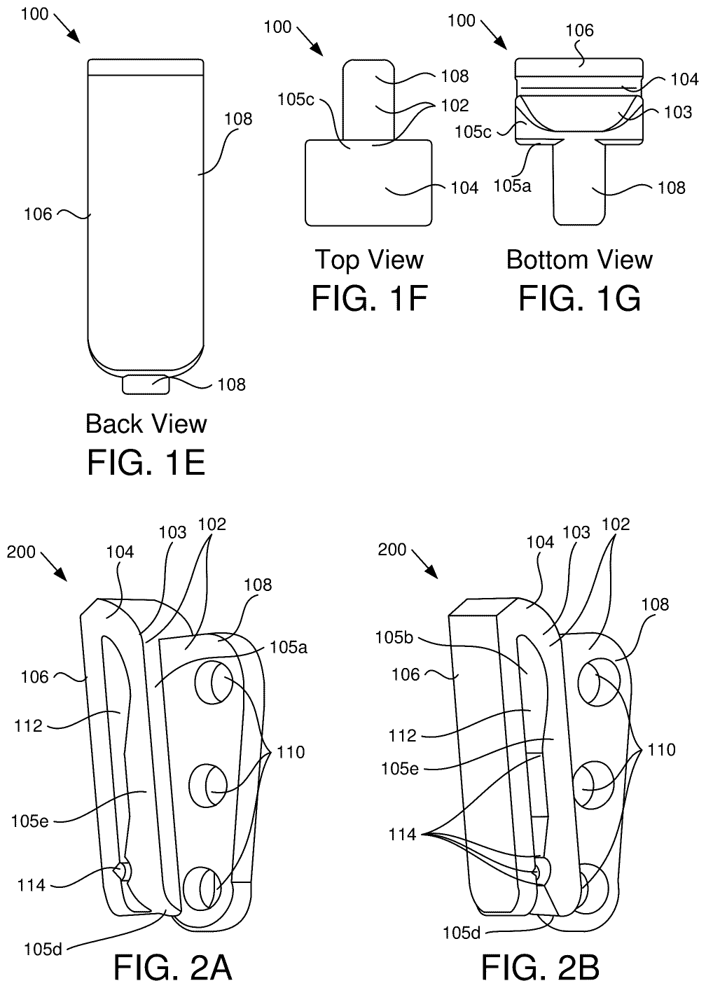

FIG. 1A is a perspective view illustrating a lockout clip 100 with two lock openings 110, according to various embodiments. FIG. 1B is another perspective view, FIG. 1C is a side view, FIG. 1D is a front view, FIG. 1E is a back view, FIG. 1F is a top view, and FIG. 1G is a bottom view illustrating the lockout clip 100 of FIG. 1A, according to various embodiments.

The lockout clip 100 includes a lockout section 102 that includes an anchor section 103 and a ridge section 108. The anchor section 103 includes a first side 105a and a second side 105b opposite the first side 105a. The anchor section 103 includes a top edge 105c and a bottom edge 105d distal to the top edge 105c. The anchor section 103 includes a first side edge 105e and a second side edge 105f distal to the first side edge 105e. The lockout section 102 includes a ridge section 108 coupled to the first side 105a of the anchor section 103 and extending away from the first side 105a of the anchor section 103. The ridge section 108 is connected to the first side 105a in a direction from the top edge 105c to the bottom edge 105d of the anchor section 103.

The ridge section 108 includes two lock openings 110. Each lock opening 110 is sized for a shackle of a padlock used to lockout access to equipment. Each lock opening 110 is oriented perpendicular to the ridge section 108. In the embodiments depicted in FIG. 1A-1G, the lockout clip 100 includes a coupling section 104 and a clip section 106. The coupling section 104 is coupled to the top edge 105c of the lockout section 102 and to a top edge of the clip section 106. In some embodiments, the coupling section 104 is shaped to maintain a gap 112 between the clip section 106 and the lockout section 102. The gap 112 is sized and shaped to allow a user to insert the lockout clip 100 over a belt, a top of pants, over a pocket, over a strap, or other convenient location to attach the lockout clip 100 to clothing of the user, to a tool bag of the user, etc.

The user is then able to connect one or two lockout padlocks to the lockout clip 100 by inserting the shackle of the lockout padlocks through the lock openings 110. The user may also connect a key to the lockout padlocks in one of the lock openings 110. For example, the user may attach the key to a carabiner that is inserted in a lock opening 110.

The top lockout opening 110 is spaced from the first side 105a of the anchor section 103 further than the bottom lockout opening 110 is spaced from the first side 105a, which facilitates padlocks anchored to the lockout clip 100 hanging more vertically than if the lockout openings 110 were vertical. In other embodiments, the lockout openings 110 are oriented vertically.

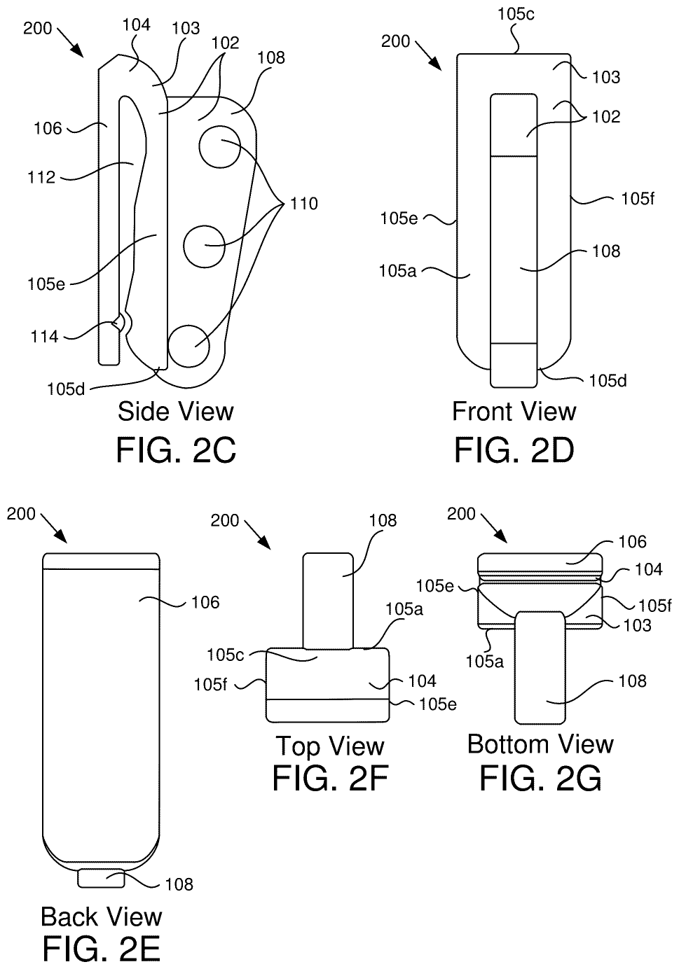

FIG. 2A is a perspective view illustrating a lockout clip 200 with three lock openings 110, according to various embodiments. FIG. 2B is another perspective view, FIG. 2C is a side view, FIG. 2D is a front view, FIG. 2E is a back view, FIG. 2F is a top view, and FIG. 2G is a bottom view illustrating the lockout clip 200 of FIG. 2A, according to various embodiments. The lockout clip 200 of FIGS. 2A-2G are substantially similar to the lockout clip 100 of FIGS. 1A-1G except with three lockout openings 110 instead of two lockout openings 110.

In some embodiments, the lockout openings 110 are arranged in a line. In other embodiments, the top lockout opening 110 is furthest from the first surface 105a of the anchor section 103, the bottom lockout opening 110 is nearest to the first surface 105a of the anchor section 103, and the middle lockout opening 110 is less than the distance away from the first surface 105a than the top lockout opening 110 and greater than the distance away from the first surface 105a than the bottom lockout opening 110. In other embodiments, the lockout openings 110 are arranged differently, such as in a vertical line.

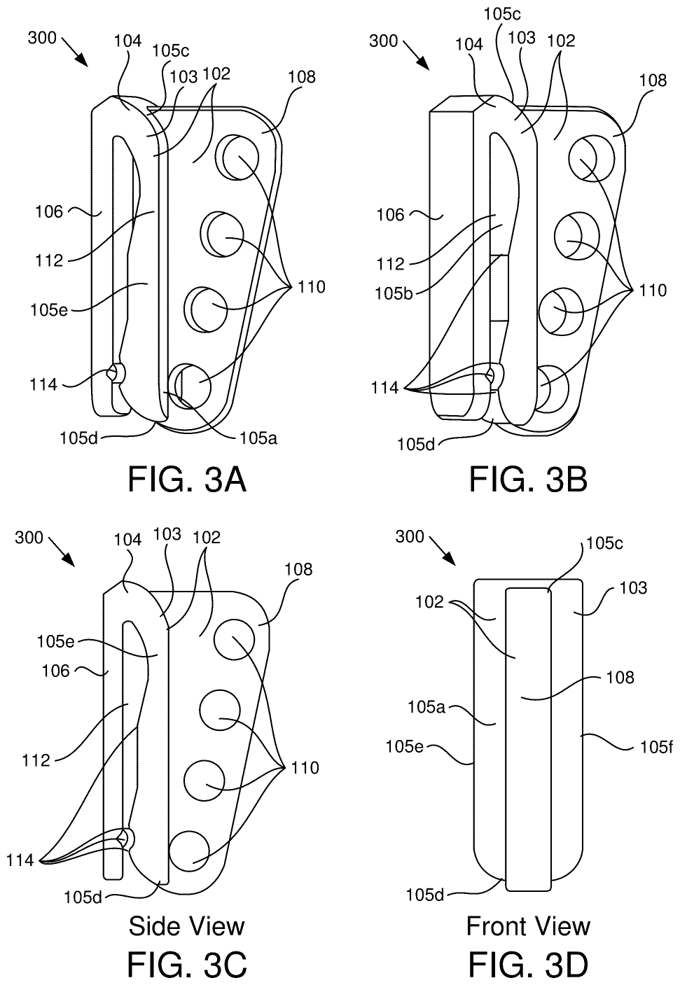

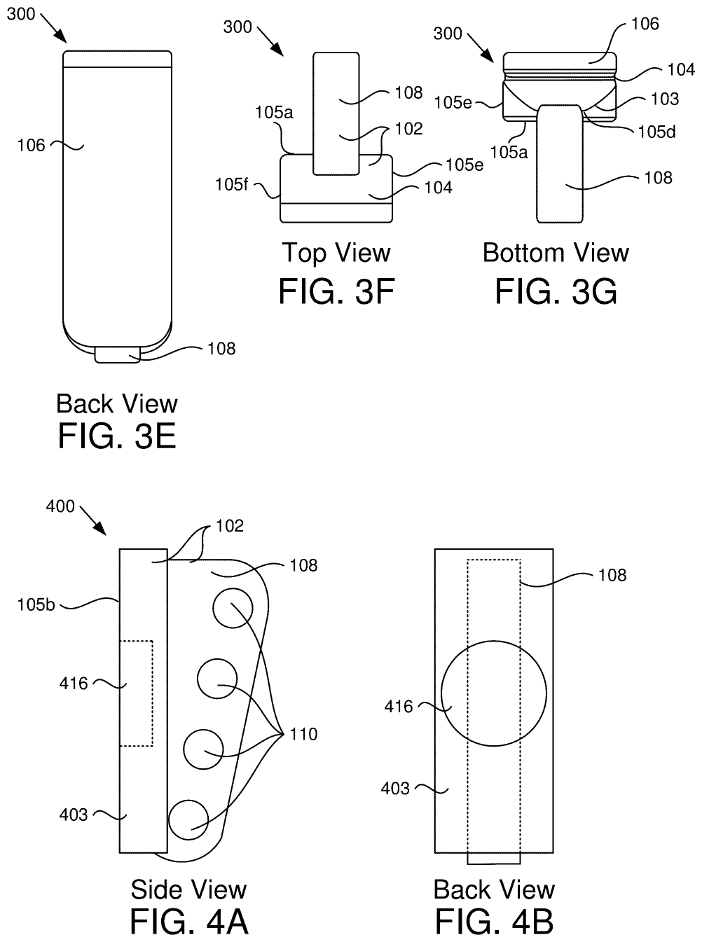

FIG. 3A is a perspective view illustrating a lockout clip 300 with four lock openings 110, according to various embodiments. FIG. 3B is another perspective view, FIG. 3C is a side view, FIG. 3D is a front view, FIG. 3E is a back view, FIG. 3F is a top view, and FIG. 3G is a bottom view illustrating the lockout clip 300 of FIG. 3A, according to various embodiments.

The lockout clip 300 of FIGS. 3A-3G are substantially similar to the lockout clip 100 of FIGS. 1A-1G except with four lock openings 110 respectively instead of two. As with the lockout clips 100, 200 of FIGS. 1A-1G and 2A-2G, the lockout openings 110 are arranged in a line with the top lockout opening 110 being the furthest from the first surface 105a of the anchor section 103. In other embodiments, the lockout openings 110 are arranged differently.

In some embodiments, lockout clips 100, 200, 300 include a ferromagnetic material. Where the lockout clips 100, 200, 300 are used in certain industries, such as in food processing plants, if all or a portion of the lockout clips 100, 200, 300 get into the food or other product, the product becomes contaminated and may necessitate disposal of a large amount of the product and may even require a recall of the product. To avoid such contamination, the lockout clips 100, 200, 300, in some embodiments, include the ferromagnetic material to be detected by a metal detector. In some embodiments, the ferromagnetic material is spread throughout the lockout clips 100, 200, 300 so that if even a small portion of the lockout clips 100, 200, 300 is broken off and is in the product, metal detectors are able to detect the portion. In some instances, the small portion may be matched to a lockout clip 100, 200, 300 where the portion was broken off which may result in less product being considered contaminated. In some embodiments, the lockout clips 100, 200, 300 are made of a non-toxic material.

In some embodiments, the lockout clips 100, 200, 300 are made of a plastic, a resin, a polymer, or other non-metallic material and include the ferromagnetic material dispersed throughout. In some embodiments, the lockout clips 100, 200, 300 are formed using injection molding or other similar manufacturing process. In other embodiments, the lockout clips 100, 200, 300 are formed using three-dimensional (“3D”) printing and the lockout clips 100, 200, 300 are made using a PLA (polylactic acid) filament or other material fed into a 3D printer. In some embodiments, the PLA filament or other material fed into the 3D printer includes the ferromagnetic material.

In some embodiments, the PLA filament or other material used to form the lockout clips 100, 200, 300 is selected based on desirable features, such as rigidity, flexibility at the coupling section 104, ultraviolet (“UV”) light resistance, durability, etc. One of skill in the art will recognize suitable materials for forming the lockout clips 100, 200, 300.

In some embodiments, the lockout clip 200 of FIGS. 2A-2G and the lockout clip 300 of FIGS. 3A-3G include protrusions 114 that extend towards the gap 112. The protrusions 114, in some embodiments, help to maintain the lockout clips 200, 300 in place over a belt, a pocket, a strap, etc. In some embodiments, the gap 112 is shaped with protrusions 114 and corresponding divots or widened sections to more easily fit over a belt, a strap, a pant top and belt, etc.

In some embodiments, the gap 112 of the lockout clips 100, 200, 300 are shaped to narrow in a direction away from the coupling section 104. As can be seen in FIGS. 1C, 2C and 3C, the gap 112 narrows towards the opening at the bottom and is wider near the coupling section 104. In some embodiments, the coupling section 104 includes a spring force configured to retain the clip section 106 positioned with respect to the lockout section 102. Thus, when a user pries the bottom of the clip section 106 away from the lockout section 102, the spring force pulls the clip section 106 back towards the lockout section 102. If a user presses the clip section 106 towards the lockout section 102, the spring force opposes the forces applied by the user to maintain a small opening at the bottom of the clip section 106. The spring force helps to retain the lockout clips 100, 200, 300 on a belt, a pant top, a pocket, a strap, etc.

In some embodiments, the gap 112 is sized to retain an article within the gap 112 such that the lockout clip 100, 200, 300 holds lockout padlocks and/or a key while the article is in the gap 112. In some examples, the gap 112 is in the range of 2 inches to 4 inches. In other examples, the gap 112 is in the range of 1 inch to 6 inches. In addition, the lockout clip 100, 200, 300 includes a sufficient width to contribute to retaining the article in the gap 112. In some examples, the lockout clip 100, 200, 300 has a width in the range of 1 inch to 2 inches. In other examples, the lockout clip 100, 200, 300 has a width in the range of half an inch to 4 inches. In some embodiments, the width of the lockout clip 100, 200, 300 and the length of the gap 112 is also sized for comfort of the user. In some examples, a thickness of the clip section 106 is sized for comfort while retaining sufficient strength to have a sufficient rigidity to maintain the shape of the clip section 106 during usage.

In some embodiments, the lock openings 110 are spaced along the ridge section 108 in a direction from the top edge 105c to the bottom edge 105d. In some embodiments, the two or more lock openings 110 are offset such that a top lock opening 110 closest to the top edge 105c is spaced farthest from the first side 105a and a bottom lock opening 110 closest to the bottom edge 105d is spaced closest to the first side 105a and any of the two or more lock openings 110 between the top lock opening 110 and the bottom lock opening 110 have a distance to the first side 105a less than the top lock opening 110 and greater than the bottom lock opening 110.

As can be seen in FIGS. 1C, 2C and 3C, the top lock opening 110 is the farthest away from the first side 105a of the anchor section 102 and the lock openings 110 below each get closer to the first side 105a of the anchor section 102. Beneficially, this arrangement facilitates the lockout padlocks hanging more vertically than if the lock openings 110 are aligned vertically. In other embodiments, the lock openings 110 are aligned differently. In some embodiments, the lock openings 110 are spaced evenly along the ridge section 108. In other embodiments, the lock openings 110 are spaced in another pattern.

In some embodiments, the anchor section 103 is wider than the ridge section 108 such that the first side 105a of the anchor section 103 extends past the ridge section 108 in a horizontal direction between the first side edge 105e and the second side edge 105e. Having the anchor section 103 wider than the ridge section 108 has some benefits, such as a wider portion within the gap 112.

FIG. 4A is a side view of a lockout clip 400 with four lock openings 110 and a magnet 416, according to various embodiments. FIG. 4B is a back view illustrating the lockout clip 400 of FIG. 4A, according to various embodiments. The lockout clip 400 of FIGS. 4A and 4B include a ridge section 108 and lock openings 110 substantially similar to the lockout clips 100, 200, 300 described above. The lockout clip 400 includes an anchor section 403 without a coupling section 104 and without a clip section 106. The anchor section 403, in some embodiments, includes a magnet 416. The magnet 416 is configured to facilitate connection to a toolbox or other metallic surface. In some instances, a user takes a toolbox to equipment being repaired so the lockout clip 400 of FIGS. 4A and 4B beneficially provides a mechanism to connect the lockout clip 400 to the toolbox. The user may also connect the lockout clip 400 to a metal surface of equipment being repaired or other nearby metallic surface. In some embodiments, a surface facing away from the lockout clip 400 is parallel to the second surface 105b of the anchor section 403. In other embodiments, surface facing away from the lockout clip 400 is recessed or protrudes slightly past the second surface 105b.

In the embodiments of FIGS. 4A and 4B, the magnet 416 is disk shaped. In such embodiments, a disk-shaped hole may be drilled into the anchor section 403 to provide an opening sized for the magnet 416. In other embodiments, the magnet 416 is shaped differently, such as having a rectangular side. In other embodiments, the lockout clip 400 includes two or more magnets 416. In such embodiments, the lockout clip 400 may include one or more magnets 416 near a top of the anchor section 403 and one or more magnets 416 near the bottom of the anchor section 403. One of skill in the art will recognize other placements of one or more magnets 416 in the anchor section 403 and other shapes of magnets 416.

In some embodiments, the magnet 416 is connected to the anchor section 403 using a press fit, an adhesive, a cement, etc. In other embodiments, the magnet 416 is formed into the anchor section 403 during manufacturing. In some embodiments, a portion of the material of the anchor section 403 covers the magnet 416. One of skill in the art will recognize other ways to attach the magnet 416 to the lockout clip 400.

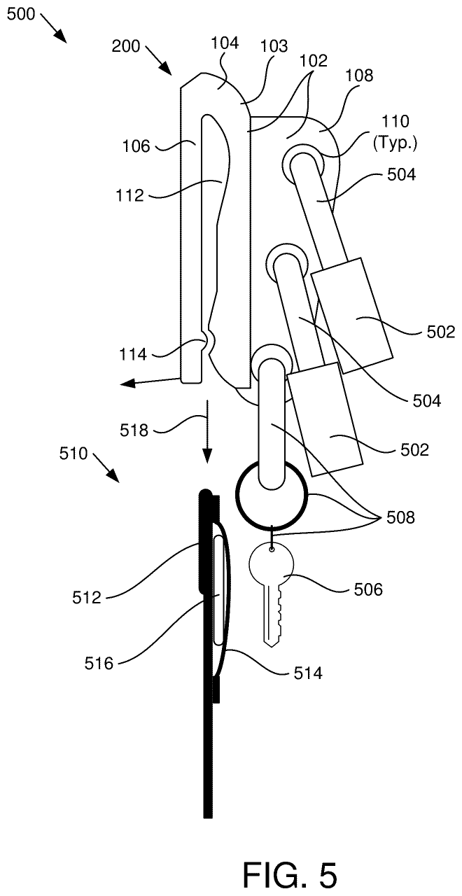

FIG. 5 is a side view 500 illustrating the lockout clip 200 of FIG. 2A with two padlocks 502 and a key holder 508 and illustrating sliding the lockout clip 200 over and article 510, such as a pant 512 with a belt 516, according to various embodiments. The key holder 508 is depicted as a carabiner with other loops and a key 506 attached to the carabiner. In other embodiments, the lockout clip 400 includes a different opening (not shown) to connect a key holder 508 and key 506.

Two lockout padlocks 502 are depicted with a shank 504 of the lockout padlocks 502 through upper lock openings 110 of the lockout clip 200. An arrow 518 pointing down depicts a direction of attaching the lockout clip 200 to an article 510 while the clip section 106 is pulled out away from the lockout section 102. An example of an article 510 where the lockout clip 200 may be attached is a pant 512 with a belt loop 514 and a belt 516. One of skill in the art will recognize other articles 510 where any of the lockout clips 100, 200, 300 with a clip section 106 may be attached. In addition, the lockout clip 400 of FIGS. 4A-4B may have lockout padlocks 502 and a key 506 attached in a similar way as depicted in FIG. 5.

The present embodiments may be embodied in other specific forms without departing from its spirit or essential characteristics. The described embodiments are to be considered in all respects only as illustrative and not restrictive. The scope of the embodiments are, therefore, indicated by the appended claims rather than by the foregoing description. All changes which come within the meaning and range of equivalency of the claims are to be embraced within their scope.

What is claimed is:

1. A lockout clip comprising:
an anchor section comprising a first side and a second side opposite the first side, a top edge, a bottom edge distal to the top edge, a first side edge, and a second side edge distal to the first side edge; and
a ridge section coupled to the first side of the anchor section and extending away from the first side of the anchor section and connected to the first side in a direction from the top edge to the bottom edge,
wherein the ridge section comprises two or more lock openings, each lock opening sized for a shackle of a padlock used to lockout access to equipment, each lock opening of the two or more lock openings oriented perpendicular to the ridge section, and
wherein the anchor section further comprises a clip and/or a magnet.

2. The lockout clip of claim 1, wherein the anchor section and the ridge section combined comprise a lockout section and wherein the clip further comprises a clip section and a coupling section, the coupling section coupled to a top edge of the clip section and to the top edge of the lockout section, the coupling section shaped to maintain a gap between the clip section and the lockout section.

3. The lockout clip of claim 2, wherein the coupling section provides a spring force configured to retain the clip section positioned with respect to the lockout section.

4. The lockout clip of claim 3, wherein the spring force is sufficient to retain an article within the gap.

5. The lockout clip of claim 4, wherein the article comprises a belt, a pant, a strap, and/or an article with a pocket and wherein a length of the gap is sized to fit over the belt, a portion of waistline of the pant, and/or a portion of a pocket of the article a sufficient amount to retain the article in the gap.

6. The lockout clip of claim 2, wherein the gap narrows in a direction away from the coupling section.

7. The lockout clip of claim 2, wherein the second side of the lockout section and/or a side of the clip section facing the gap comprise one or more protrusions that extend in a direction towards the gap.

8. The lockout clip of claim 1, wherein the lockout clip comprises a ferromagnetic material.

9. The lockout clip of claim 8, wherein the lockout clip comprises a non-metallic material with the ferromagnetic material spread throughout the non-metallic material.

10. The lockout clip of claim 9, wherein the non-metallic material with the ferromagnetic material is a material suitable for a three-dimensional (“3D”) printer and/or injection molding.

11. The lockout clip of claim 1, wherein the two or more lock openings are spaced along the ridge section in a direction from the top edge to the bottom edge.

12. The lockout clip of claim 1, wherein the two or more lock openings are offset such that a top lock opening of the two or more lock openings closest to the top edge is spaced farthest from the first side and a bottom lock opening of the two or more lock openings closest to the bottom edge is spaced closest to the first side and any of the two or more lock openings between the top lock opening and the bottom lock opening have a distance to the first side less than the top lock opening and greater than the bottom lock opening.

13. The lockout clip of claim 1, wherein the two or more lock openings are spaced apart along a line.

14. The lockout clip of claim 1, wherein the first side of the anchor section extends past the ridge section in a horizontal direction between the first side edge and the second side edge.

15. A lockout clip comprising:
a lockout section comprising:
an anchor section comprising a first side and a second side opposite the first side, a top edge, a bottom edge distal to the top edge, a first side edge, and a second side edge distal to the first side edge; and
a ridge section coupled to the first side of the anchor section and extending away from the first side of the anchor section and connected to the first side in a direction from the top edge to the bottom edge,
wherein the ridge section comprises two or more lock openings, each lock opening sized for a shackle of a padlock used to lockout access to equipment, each lock opening of the two or more lock openings oriented perpendicular to the ridge section;
a coupling section; and
a clip section, the coupling section coupled to a top edge of the clip section and to the top edge of the lockout section, the coupling section shaped to maintain a gap between the clip section and the lockout section.

16. The lockout clip of claim 15, wherein the coupling section provides a spring force configured to retain the clip section positioned with respect to the lockout section.

17. The lockout clip of claim 15, wherein the gap narrows in a direction away from the coupling section.

18. The lockout clip of claim 15, wherein:
the lockout clip comprises a ferromagnetic material;
the two or more lock openings are spaced along the ridge section in a direction from the top edge to the bottom edge;
the two or more lock openings are offset such that a top lock opening of the two or more lock openings closest to the top edge is spaced farthest from the first side and a bottom lock opening of the two or more lock openings closest to the bottom edge is spaced closest to the first side and any of the two or more lock openings between the top lock opening and the bottom lock opening have a distance to the first side less than the top lock opening and greater than the bottom lock opening; and/or
the two or more lock openings are spaced apart along a line.

19. A lockout clip comprising:
an anchor section comprising a first side and a second side opposite the first side, a top edge, a bottom edge distal to the top edge, a first side edge, and a second side edge distal to the first side edge;
a ridge section coupled to the first side of the anchor section and extending away from the first side of the anchor section and connected to the first side in a direction from the top edge to the bottom edge, wherein the ridge section comprises two or more lock openings, each lock opening sized for a shackle of a padlock used to lockout access to equipment, each lock opening of the two or more lock openings oriented perpendicular to the ridge section; and
a magnet disposed within the second side of the anchor section.

20. The lockout clip of claim 19, wherein the magnet comprises an outer side facing away from the anchor section, the outer side configured to be flush with the second side of the anchor section.
